(19) United States
(12) Patent Application Publication
(10) Pub. No.: US 2019/0126499 A1
(43) Pub. Date: May 2, 2019

(54) FOLDING TOOL WITH AN ASSISTED OPENING MECHANISM

(71) Applicant: SPORT MANUFACTURING GROUP INC., Forest Hills, NY (US)

(72) Inventor: Anton Tkachenko, St. Petersburg (RU)

(21) Appl. No.: 15/798,509

(22) Filed: Oct. 31, 2017

(51) Int. Cl. B26B 1/04

(52) U.S. Cl. CPC B26B 1/042; B26B 1/046

(57) ABSTRACT

A folding knife includes a handle and a blade, rotatably connected to the handle with an axial shaft. The handle has two or more parts, together the parts of the handle form a cavity in which the blade is placed in the closed position. The blade has a working sharpened edge and a shank, and rotates about the axial shaft from the closed position, in which the working sharpened edge of the blade is positioned within the cavity, to the open position, in which the working sharpened edge of the blade protrudes from the handle and allows the cutter to be used. One of the parts of the handle includes an additional recess containing a zigzag spring and a hook. One end of the spring is connected to the handle, and its other end is connected to the hook. The hook is pivotally connected to the blade of the knife and transmits to it the force of the stretched spring, which allows the knife to open under the force of compression of the spring. The shape of the hook is such that it partially encircles the axis of the knife, and the place where the hook is connected to the blade is such that the folded knife does not open under the influence of the spring until the user withdraws the blade from the folded position to a certain angle, thereby initiating further opening of the knife under the influence of the spring.

### BACKGROUND OF THE INVENTION

This invention relates generally to foldable knives, and more generally to folding tools, a blade or working part of which can be opened by the action of an elastic element (spring), and where such action is initiated only after the knife or tool is partially opened by its user.

Folding knives and folding tools used for various purposes are known from the prior art. Many such knives and tools consist of a blade or a working part and a handle connected to each other with an axle. To open such tools or knives into the working (i.e., open) position, it is necessary to act in some way on the closed blade. For example, the blade can be opened using two hands, where the user holds the handle of the knife with one hand and pulls the blade into the open position with the second hand. Alternatively, the blade can be opened with one hand, where the user holds the handle in the palm of his/her hand and with one finger of the same hand moves the blade from the closed position until it is fully opened. In such configuration, the user's finger typically acts on an additional device attached to the blade, such as a thumb stud, thumb disc or a special part of the blade itself, e.g., a hole, notch or protrusion. Similarly, opening of the knife with one hand can be performed by an inertial movement of the blade from the folded position into the unfolded position.

While various combinations of the above opening methods are possible, generally, all of these ways of opening the folding knife can be attributed to a manual type, since the movement of the blade from the folded position into the unfolded position occurs under the influence of the muscular force of the user or by inertia caused by the application of such force. Manual opening of a knife is quite convenient for the user, but requires a certain skill at the opening. There is always a possibility of incomplete opening when user applies insufficient force to the blade. Undesirable consequences of incomplete opening of the folding knife may be delays in the use of the knife, loss of time, inconvenience and even injury, because the incompletely opened blade is not fixed in one position.

Another known type of opening mechanisms of folding knives is the automatic opening. In knives with this type of opening, knife's mechanism includes a spring connected to the handle and to the blade of the knife in such a way that, under its influence, the blade opens. Folded blade is held in the closed position with the help of a special mechanism, while the spring is tense. When the user activates the blade release mechanism, the spring pushes the blade into the unfolded position. Advantages of this type of knife opening mechanism include faster opening, practically guaranteed successful opening of the knife, and simplicity of actions from the user's point of view. However, there are several disadvantages. First, knives with automatic opening mechanisms are more dangerous in daily use due to the probability of unexpected opening due to carelessness of the user. Second, such knives require use of locking mechanisms for the blade both in the closed and the open position, and, consequently, are often more expensive to manufacture than folding knives with a manual opening type. Third, knives with automatic opening are prohibited in a number of regions and countries in the world in general and in many US states, in particular.

To address the above deficiencies, another type of opening mechanism of folding knives has been conceived. It is the assisted opening mechanism, which is, in fact, a combination of the above two types incorporating main advantages of each of them. A folding knife containing an assisted opening mechanism utilized an action of the elastic element of this mechanism to spread the knife automatically, but only after the user himself withdraws the blade from the folded position to a certain angle. Thus, this type of mechanism assists the user only after a certain effort to open the knife is applied by the user and then spreads the knife or tool without any further efforts on the part of the user.

There are many different versions of the implementation of the assisting opening mechanism, but our mechanism presented in this document differs in the novelty of its device.

### SUMMARY OF THE INVENTION

It is an object of the present invention to provide a folding knife which includes a handle and a blade, rotatably connected to the handle with an axial shaft. The handle has two or more parts, together the parts of the handle form a cavity in which the blade is placed in the closed position. The blade has a working sharpened edge and a shank, and rotates about the axial shaft from the closed position, in which the working sharpened edge of the blade is positioned within the cavity, to the open position, in which the working sharpened edge of the blade protrudes from the handle and allows the cutter to be used. One of the parts of the handle includes an additional recess containing a zigzag spring and a hook. One end of the spring is connected to the handle, and its other end is connected to the hook. The hook is pivotally connected to the blade of the knife and transmits to it the force of the stretched spring, which allows the knife to open under the force of compression of the spring. The shape of the hook is such that it partially encircles the axis of the knife, and the place where the hook is connected to the blade is such that the folded knife does not open under the influence of the spring until the user withdraws the blade from the folded position to a certain angle, thereby initiating further opening of the knife under the influence of the spring.

The above aspects, advantages and features are of representative embodiments only. It should be understood that they are not to be considered limitations on the invention as defined by the claims. Additional features and advantages of the invention will become apparent in the following description, from the drawings, and from the claims.

### BRIEF DESCRIPTION OF THE DRAWINGS

The invention is illustrated by way of examples which are not a limitation, and the figures of the accompanying drawings in which references denote corresponding parts, and in which:

FIG. 1 is a perspective view of a folding knife with the invented and described mechanism. The knife blade is in the folded (i.e., closed or stowed) position.

FIG. 2 is a perspective view of the folding knife with the invented and described mechanism. The blade is in the working (i.e., open or unfolded) position.

FIG. 3 is a spatial explosion view of the knife shown in FIG. 1 and FIG. 2

FIG. 4 is a side view of the knife shown in FIG. 1 and FIG. 2. The knife blade is in the folded (closed) position. The left half of the handle is not shown, so the main elements of the inventive mechanism are visible.

FIG. 5 is a side view of the knife shown in FIG. 1 and FIG. 2. The knife blade is in half-opened/half-closed position. The left half of the handle is not shown, so the main elements of the inventive mechanism are visible.

FIG. 6 is a side view of the knife shown in FIG. 1 and FIG. 2. The knife blade is in the open (working) position. The left half of the handle is not shown, so the main elements of the invented lock are visible.

### DETAILED DESCRIPTION

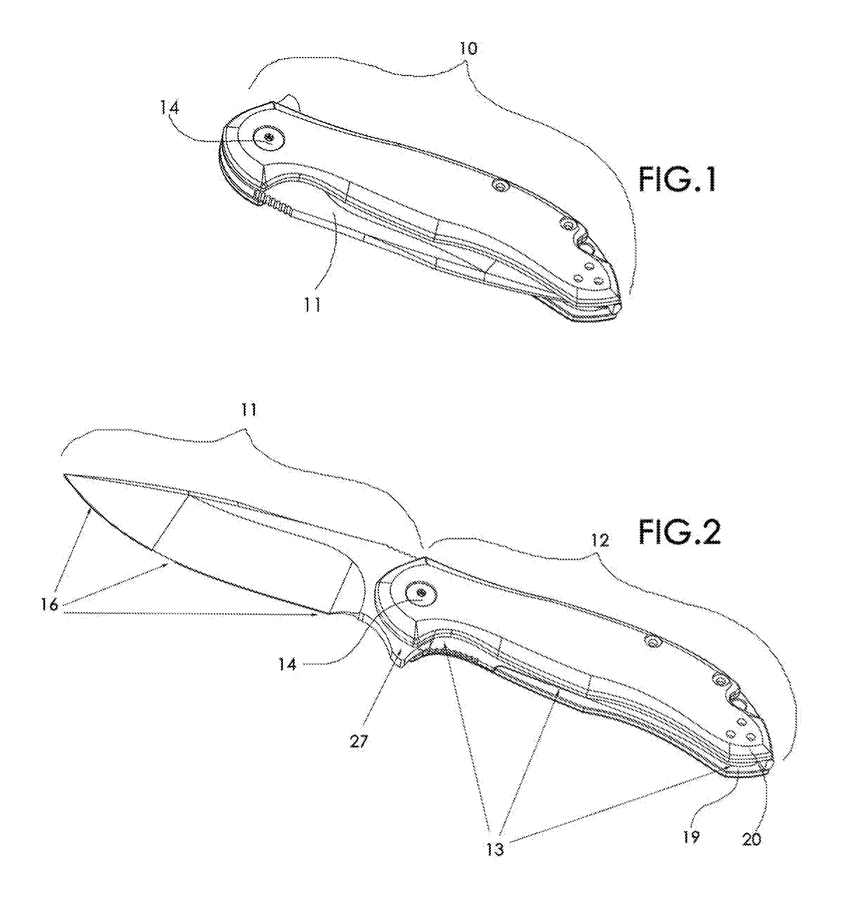

FIG. 1 shows a perspective view of a folding knife 10 containing the invented and described mechanism. Blade 11 of the folding knife 10 is in the folded (closed) position, in which the blade is partially located inside a cavity 13 formed by halves 19 and 20 of a handle 12.

FIG. 2 shows a perspective view of the folding knife 10 containing the invented and described mechanism. Blade 11 of the knife 10 is in the open (working) position and protrudes from the handle 12. Blade 11 includes a shank 17, which is positioned in the cavity 13 between the halves 19 and 20 of the handle 12.

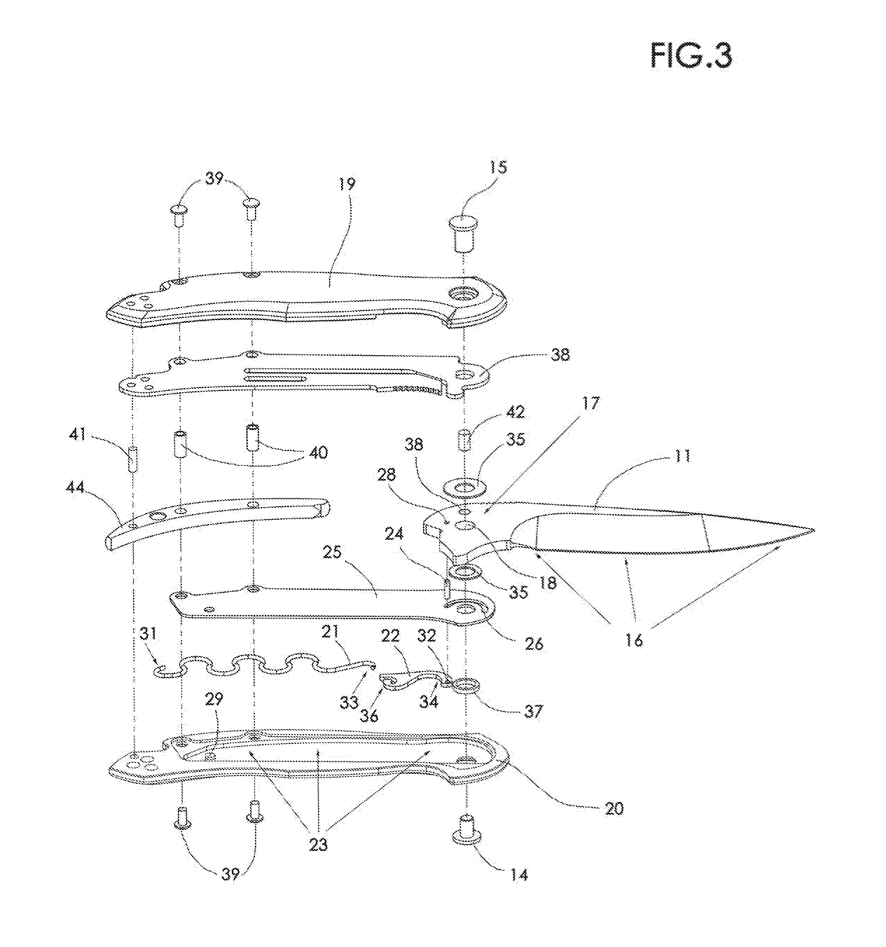

FIG. 3 shows the spatial explosion of the folding knife shown in FIG. 1 and FIG. 2.

As shown in the central part of FIG. 3, the blade 11 includes an axial hole 18 located in the shank 17. Shaft 15 is positioned in the axial hole 18 so as to enable the rotation of the blade. Shank 17 also includes a hole 28 with a pin 24, which rotatably connects the blade 11 with a hook 22.

Blade 11 also has a sharpened edge 16 and a hole 38, into which a locking pin 42 is installed. The locking pin 42 limits movement of the blade from the folded position into the unfolded position. Washers 35 are put on the shaft 15 on both sides of the blade and serve for a smooth movement of the blade.

The top portion of FIG. 3 shows the right half 19 of the handle 12 and, below it, a metal liner 38, which performs the function of locking the blade in the folded and unfolded positions.

The left half 20 of the handle 12 is shown in FIG. 3 below the blade 11. Left half 20 includes a recess 23 in which, when the blade 11 is folded, a zigzag spring 21 with the connected hook 22 are positioned. Zigzag spring 21 is preferably flat in plan and is parallel to the plane of symmetry of the blade. Element 29 is formed either as a separate element or as a unitary element with the handle half 20. Element 29 serves to engage bend 31 of the spring 21 to the handle 12, thus allowing the spring to stretch. Optionally, an abutment sleeve 37 can also be positioned in the recess 23. Abutment sleeve 37 can be mounted on the shaft 15 to provide rigidity of the axial connection. In addition, FIG. 3 shows a cover 25 covering the recess 23 and preventing the elements in the recess 23 from falling out and from contamination.

Sleeves 40, screws 39, spacer 44, and pin 41 serve only to assemble the handle halves 19 and 20 to each other and are not pertinent to the present invention.

It should also be noted that the elements 35, 37, 38, 42, 41, 39, 40 and 44 are not essential in the construction of the folding knife containing the described invention. Essential elements of the inventive mechanism are the elements 15, 20, 21, 22, 23, 24, 25, 29, 37 and the blade 11, as well as, of course, separately described parts of these elements, such as holes, bends, recesses and protrusions thereon.

The following description explains the principles of the invented mechanism.

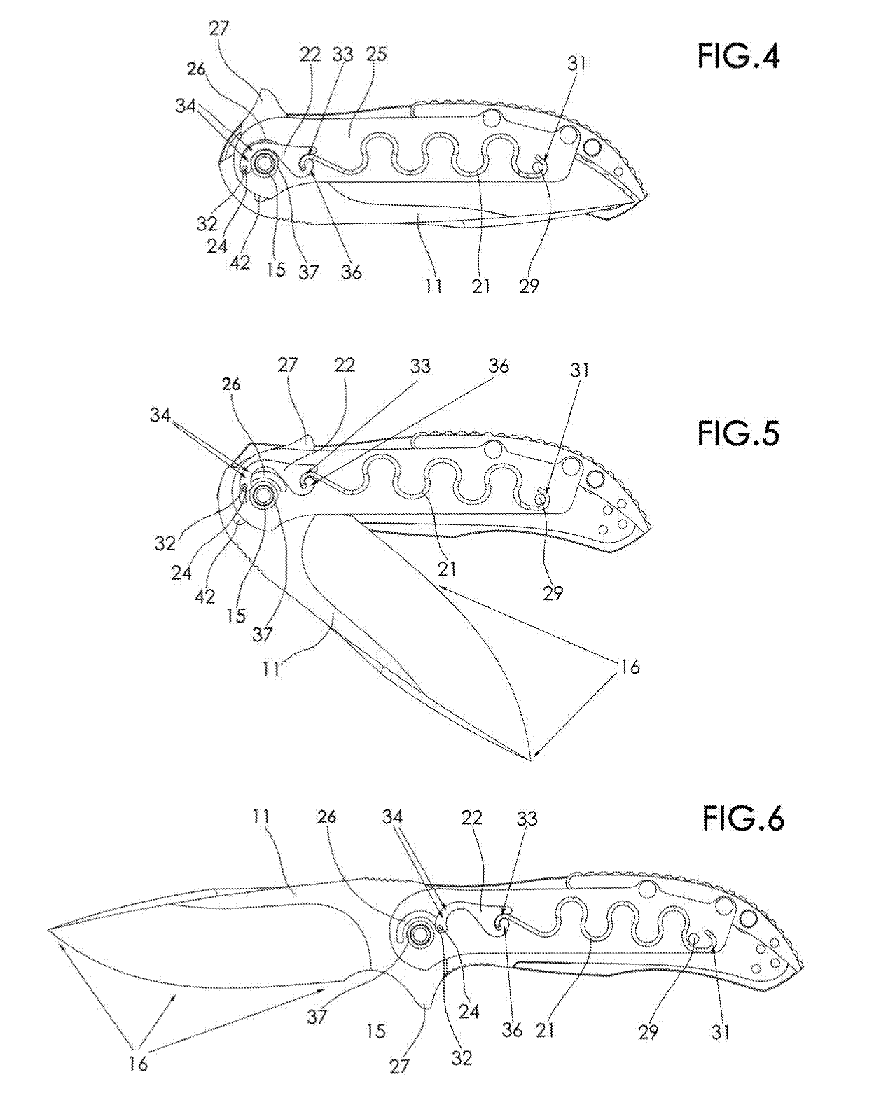

FIG. 4 shows the left view of the folding knife 10. The left half 20 of the handle 12 is not shown, which allows a viewer to see the elements of the mechanism and to see how it works. Blade 11 is shown in the folded position, and the zigzag spring 21 is shown in its stretched tension position. One end of the spring 21 has a bend 31, by which the spring 21 is movably engaged by the half 20 of the handle 12 using the element 29. The other end of the spring 21 has a bend 33, by which the spring 21 is movably engaged with a protrusion 36 of the hook 22. I-look 22, in turn, includes an opening 32 pivotally connecting the hook to the blade 11 by means of a pin 24 inserted into the opening 32 and pressed or screwed into the blade 11. Thus, the spring 21 through the hook 22 and the pin 24 movably engages the handle half 20 with the blade 11 and, in case of its elongated extension, can transfer the force to the blade 11 resulting in rotation of the blade 11 about the shaft 15 passing through the hole 18.

As further shown in FIG. 4, when the blade 11 is folded, the hook 22 partially encircles the shaft 15 (and the abutment sleeve 37 applied thereto) with its bend 34. This position of the hook 22 is due to the position of the hole 28 in the blade 11, to which the hook 22 is pivotally attached by the pin 24 inserted into the hole 28.

In this way, the elastically stretched spring 21 is held by the bend 34 of the hook 22 in a tensioned stretched position, and the blade 11 of the folding knife 10 does not receive any force from the side of the spring that can lead to the opening of the knife. Protrusion 27 extends beyond the boundaries of the handle and serves to apply a rotational force to the blade 11 by pressing the user's finger against the protrusion.

FIG. 5 shows the left side view of the folding knife 10. The left half of the handle 20 is not shown, allowing a viewer to see the elements of the mechanism and follow the principles of its operation.

Blade 11 is shown in a partially unfolded position, and the zigzag spring 21 is in its stretched tension position. The protrusion 27 of the blade 11 is partially but not completely concealed within the handle that demonstrates the approximate range of motion of the blade 11 under the influence of the user's finger pressure on the protrusion 27.

As shown in FIG. 5, when the blade 11 is already in a partially unfolded position, the position of the hook 22 rotatably connected to the blade 11 by means of the pin 24 is such that the bend 34 of the hook 22 no longer covers the shaft 15 (and the abutment sleeve 37), and, consequently, the hook 22 is no longer engaged with the axis 15. The energy of the tensely stretched spring begins to be released due to its ability to contract and to pull the blade 11 by means of a hook 22 pivotally connected to the blade 11 by the pin 28.

FIG. 6 shows the left side view on the folding knife 10. The left half of the handle 20 is not shown, which allows a viewer to see the elements of the mechanism and follow the principles of its operation.

Blade 11 is shown in the unfolded position, and the zigzag spring 21 is in its free unstressed position. The size of the bend 31 of the spring 21 is preferably selected so as to allow the spring to partially move within the recess 23 along the plane of the cover 25. This makes it easier to fold the unfolded knife 10, since the blade can be folded to some angle without stretching the spring, which in turn allows for unlocking of the knife's lock following by a comfortable folding without having to restrain the action of the spring 21.

After the user moves the blade 11 of the knife 10 into the folded position, breaking the resilient resistance of the spring 21, the knife 10 will be in the position described in FIG. 4 and will again be ready for unfolding.

In the preceding specification, the invention has been described with reference to specific exemplary embodiments thereof. It will however, be evident that various modifications and changes may be made thereto without departing from the broader spirit and scope of the invention as set forth in the claims that follow. The specification and drawings are accordingly to be regarded in an illustrative manner rather than a restrictive sense.

I claim as follows:

1. A folding knife, comprising:
a handle having at least two parts connected to each other to form a cavity therebetween, at least one of said two parts of the handle having a recess formed therein;
a blade having at least one sharpened edge and a shank with an axial hole and an axial shaft positioned in said axial hole, said blade being rotatable around said axial shaft between an open position, in which said sharpened edge of said blade extends outside said cavity and said shank is located inside said cavity, and a closed position, in which said sharpened edge of said blade and said shank are both located inside said cavity;
a hook element located within said recess, said hook element having a first end pivotally connected to said shank of said blade, a curved depression and a second end; and
a spring element located within said recess, said spring element having a first end connected to said second end of said hook element and a second end connected to said one of said two parts of the handle in which said recess is formed,
wherein, when said blade is in its closed position said curved depression of said hook at least partially abuts an outside periphery of said axial shaft; and wherein, when said blade is in its open position, said axial shaft is located outside of said curved depression and adjacent to the first end of said hook.

2. The folding knife according to claim 1, wherein said spring element is a zig-zag spring and wherein both said first end of said spring element and said second end of said spring element are bent.

3. The folding knife according to claim 2, wherein said second end of said hook element includes a protrusion engaging said bent first end of said zig-zag spring.

4. The folding knife according to claim 3, wherein said recess is covered by a cover located between the blade and said one of said two parts of the handle in which said recess is formed.

5. The folding knife according to claim 4, wherein said blade further comprises a supporting part configured to allow a user to initiate blade movement from the closed position.

6. A folding instrument, comprising:
a handle having at least two parts connected to each other to form a cavity therebetween, at least one of said two parts of the handle having a recess formed therein;
a tool having at least one working end and a shank with an axial hole and an axial shaft positioned in said axial hole, said tool being rotatable around said axial shaft between an open position, in which said working end of said tool extends outside said cavity and said shank is located inside said cavity, and a closed position, in which said working end of said tool and said shank are both located inside said cavity;
a hook element located within said recess, said hook element having a first end pivotally connected to said shank of said tool, a curved depression and a second end; and
a spring element located within said recess, said spring element having a first end connected to said second end of said hook element and a second end connected to said one of said two parts of the handle in which said recess is formed,
wherein, when said tool is in its closed position said curved depression of said hook at least partially abuts an outside periphery of said axial shaft; and wherein, when said tool is in its open position, said axial shaft is located outside of said curved depression and adjacent to the first end of said hook element.

7. The folding instrument according to claim 6, wherein said spring element is a zig-zag spring and wherein both said first end of said spring element and said second end of said spring element are bent.

8. The folding instrument according to claim 7, wherein said second end of said hook element includes a protrusion engaging said bent first end of said zig-zag spring.

9. The folding instrument according to claim 8, wherein said recess is covered by a cover located between the tool and said one of said two parts of the handle in which said recess is formed.

10. The folding instrument according to claim 9, wherein said tool further comprises a supporting part configured to allow a user to initiate blade movement from the closed position.
